(19) United States
(12) Patent Application Publication
(10) Pub. No.: US 2013/0128956 A1
(43) Pub. Date: May 23, 2013

(54) APPARATUS AND METHOD FOR RECEIVING SIGNALS

(71) Applicant: Aaron Reel Bouillet, Noblesville, IN (US)

(72) Inventor: Aaron Reel Bouillet, Noblesville, IN (US)

(73) Assignee: THOMSON LICENSING, Issy de Moulineaux (FR)

(21) Appl. No.: 13/813,203

(22) PCT Filed: Aug. 6, 2010
(86) PCT No.: PCT/US10/44666

§ 371 Date: Jan. 30, 2013

(51) Int. Cl. H04N 7/26

(52) U.S. Cl. CPC H04N 19/00139
USPC 375/240.02; 375/240.26; 375/240.28

(57) ABSTRACT

A method of receiving a signal contains a first data stream at a first encoding rate and a second stream at a second encoding rate, outputting content from the first data stream if an error value of the first data stream is below a first error value, and outputting content from the second data stream if the error value of the first stream is above the first error value. An apparatus has a demodulator that receives a signal containing a first portion encoded at a first encoding rate and a second portion encoded at a second encoding rate, a controller that determines whether an error rate of a decoded first portion is above a first error rate, and an output driver that provides a video signal from a decoded second portion if the decoded first portion is above the first error rate.

### FIELD OF THE INVENTION

The present disclosure relates generally to the operation of a digital signal data transmission system and more specifically to the transmitting, receiving, and decoding of data for broadcast television that includes video signals having more than one video encoding level and more than one reception performance level.

### BACKGROUND OF THE INVENTION

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Television broadcast systems throughout the world have migrated from the delivery of analog audio and video signals to the delivery of digital audio video using modern digital communications systems. For example, in the United States, the Advanced Television Standards Committee (ATSC) has developed a standard called “ATSC Standard: Digital Television Standard A/53” (the A/53 standard). The A/53 standard defines how data for digital television broadcasts should be encoded and decoded. In addition, the U.S. Federal Communications Commission (FCC) has allocated portions of the electromagnetic spectrum for television broadcasts. The FCC assigns a contiguous 6 Megahertz (MHz) channel within the allocated portion to a broadcaster for transmission of terrestrial (i.e., not cable or satellite) digital television broadcasts. Each 6 MHz channel has a channel capacity of approximately 19 Megabits (Mb)/second based on the encoding and modulation format in the A/53 standard. Furthermore, the FCC has mandated that transmissions of terrestrial digital television data through the 6 MHz channel must comply with the A/53 standard.

Digital broadcast signal transmission standards, such as the A/53 standard, define how source data (e.g., digital audio and video data) should be processed and modulated into a signal that is transmitted through the channel. The processing adds redundant information to the source data so that a receiver that receives the signal from the channel may recover the source data, even if the channel adds noise and multi-path interference to the transmitted signal. The redundant information added to the source data reduces the effective data rate at which the source data is transmitted but increases the potential for successful recovery of the source data from the transmitted signal.

The A/53 standard development process was focused on high definition television (HDTV) and fixed reception. The system was designed to maximize video bit rate for the large high resolution television screens that were already beginning to enter the market. However, transmissions broadcast under the ATSC A/53, or legacy encoding and transmission standard, present reception difficulties for mobile receivers.

Recognizing this fact, in 2007, the ATSC announced the launch of a process to develop a standard that would enable broadcasters to deliver television content and data to mobile and handheld devices via their digital broadcast signal. Changes to the legacy transmission standard include an additional encoding scheme to introduce further data redundancy. The additional encoding has been adapted to better perform with advanced receivers in mobile, handheld and pedestrian devices while still remaining backward compatible with the legacy A/53 standard. The new standard, known as A/153, also allows operation of existing ATSC services in the same radio frequency (RF) channel without an adverse impact on existing receiving equipment.

Although the inclusion of the additional mobile and handheld signal, known as an ATSC M/H signal, along with the legacy ATSC signal does not impair legacy reception, the additional signal is intended as a separate signal, or subchannel, within the broadcast channel signal. More importantly, the ATSC M/H signal is not normally provided as an augmentation to the legacy broadcast signal and as such is not intended to enhance the performance and user experience of the reception of the legacy signal. The present disclosure overcomes this deficiency by providing a system and method that is capable of using an advanced mobile and pedestrian signal, such as ATSC M/H, to enhance the performance and user experience of fixed reception systems, such as the existing legacy ATSC broadcast system.

### SUMMARY OF THE INVENTION

In accordance with an aspect of the present disclosure, a method is provided that includes the steps of receiving a signal containing a first data stream at a first encoding rate and a second data stream at a second encoding rate, outputting content from the first data stream if an error value of the first data stream is below a first error value, and outputting content from the second stream if the error value of the first data stream is above the first error value.

In accordance with another aspect of the present disclosure, a signal receiving apparatus is provided that includes a demodulator that receives a signal containing a first portion encoded at a first encoding rate and a second portion encoded at a second encoding rate, a controller coupled to the demodulator that determines whether an error rate of a decoded first portion of the signal is above a first error rate, and an output driver coupled to the controller that provides a video signal from a decoded second portion of the signal if the decoded first portion of the signal is above the first error rate.

In accordance with another aspect of the present disclosure, a method for displaying selections for a signal decoding process on an interactive graphic display in response to an input device is provided that includes displaying a plurality of visual elements associated with decoding a received signal containing a first data stream encoded at a first encoding rate and a second data stream encoded a second encoding rate and selecting a decoding process for the received signal in response to a user input. The decoding process further includes outputting first content from the first data stream if an error value of the first data stream is below a first error value and outputting second content from the second data stream if the error value of the first data stream is above the first error value.

### BRIEF DESCRIPTION OF THE DRAWINGS

In the drawings:

FIG. 1 is a block diagram of a signal transmission system of the present disclosure;

FIG. 2 is a block diagram of an embodiment of an exemplary signal transmitter of the present disclosure;

FIG. 3 is a block diagram of an embodiment of an exemplary signal receiver of the present disclosure;

FIG. 4 is a flow chart of an exemplary process for encoding a signal according to the present disclosure;

FIG. 5 is a flow chart of an exemplary process for decoding a signal according to the present disclosure; and

FIG. 6 is a diagram illustrating an exemplary user interface for decoding a signal according to the present disclosure.

The characteristics and advantages of the present disclosure may become more apparent from the following description, given by way of example.

### DETAILED DESCRIPTION

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit. elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort would nevertheless be a routine undertaking of design, fabrication, and manufacture for those of ordinary skill having the benefit of this disclosure.

The following describes a system relating to television broadcast signals, and more particularly to broadcast signals as defined for use in the United States. The embodiments described may generally be used in a signal transmitting facility as well as at a user's premises. Examples of devices incorporating the embodiments include, but are not limited to, settop boxes, laptop or desktop computers, monitors, and televisions. Other systems utilized to transmit and receive other types of signals may include similar structures and processes. Those of ordinary skill in the art will appreciate that the embodiments of the circuits and processes described herein are merely one set of potential embodiments. It is important to note that signals compliant with broadcast and wireless standards other than the A/53 and A/153 standard, in general, may be transmitted and received in a manner similar to those described here. As such, in alternate embodiments, the components of the system may be rearranged or omitted, or additional components may be added. For example, with minor modifications, the system described may be configured for use in the digital video broadcast-terrestrial (DVB-T) broadcast services used elsewhere in the world.

The embodiments described below are primarily related to transmission and reception of signals, and in particular to the transmission and reception of broadcast signals encoded to include a first encoded signal stream, such as a legacy ATSC broadcast signal, and second encoded signal stream, such as an ATSC M/H broadcast signal. Certain aspects of the embodiments including, but not limited to, certain control signals and power supply connections have not been described or shown in the figures but may easily be ascertained by a skilled artisan. It should be noted that the embodiments may be implemented using hardware, software, or any combination of both, including the use of a microprocessor and program code or custom integrated circuits. It should also be noted that some of the embodiments may involve iterative operation and connection between the various elements of the embodiment. Alternative embodiments may be possible using pipelining architectures employing repeated identical elements, connected in series, in place of, or in addition to, the iterative operation embodiments described herein.

The disclosed embodiments describe a transmitting apparatus and method for a broadcast signal that includes processing a data stream of content (e.g. audio, video, data), as a first stream, encoded at a higher data rate and producing an output signal containing the higher quality level video for display on a video display in a home. The transmitting apparatus and method also includes processing the same or similar content, as a second stream, encoded at a lower data rate and producing an output signal, included with the first signal, with the lower quality level video for display on a video display used with a portable or mobile device. The transmission apparatus and method may also include synchronization between the first stream and the second stream and may produce synchronization data for the video content in each of the streams included in the combined broadcast signal.

The embodiments also describe an apparatus and method for receiving a signal that contains a first stream encoded using a first encoding rate or format that produces a first quality level of picture output for display, and a second stream containing the same or similar content encoded using a second encoding rate or format that is higher, or more robust, than the first rate format that produces a second quality level of picture output for display that is lower than the first quality level. The second stream having the second quality level of picture output may include lower video resolution and also may include lower scan rate resolution, among other characteristic differences, than the second stream having first quality level of picture output.

The receiver embodiments decode the first stream and provide the first decoded stream for display if the decoding error rate remains below a first decoded signal error rate level. The receiver embodiments may also decode the second stream and provide the second decoded stream for display if the decoding error rate goes above the first decoded signal error level. The receiver embodiments may decode the first and second streams simultaneously or alternatively may decode the second stream only if the first decoded signal error is above a second error level that is below the first error level. The receiver embodiments may further include the ability to disable the decoding of the second stream under certain receiving conditions such as when the error rate of the first decoded stream is below a second error rate which is lower than the first error rate. The receiver embodiments, may also include the ability to synchronize the outputs of the two decoded streams for a seamless display transfer. The receiver embodiments may adjust one or more video signal characteristics of the second stream in order to display the second stream on the display device used for the first quality level of picture output.

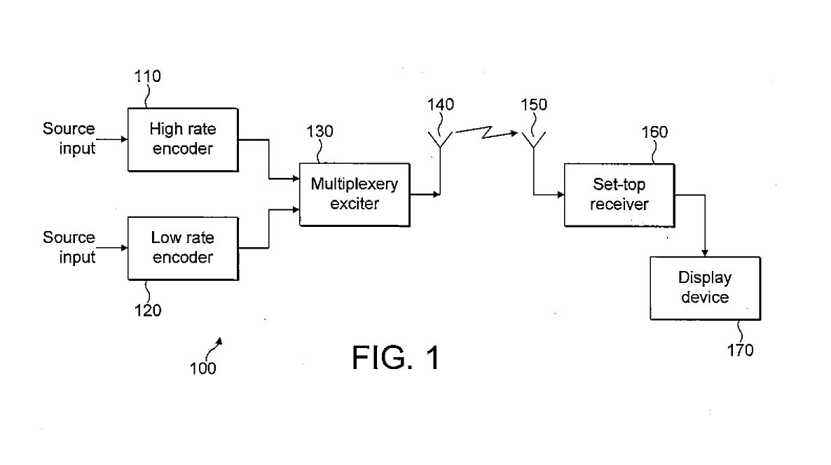

Turning now to FIG. 1, a block diagram of an embodiment of a signal transmission system 100 according to aspects of the present disclosure is shown. System 100 is particularly suited for use with broadcast signals that can be transmitted with two or more signal encoding formats, such as is used in the ATSC A/153 standard. On the signal transmitter side of FIG, 1, a first data stream, such as an audio/video stream compression according to the motion picture entertainment group (MPEG) standard MPEG-2, at a first input source is connected to high rate encoder 110. A second data stream that may also use audio/video stream compression, such as MPEG-2 compression, is connected to a low rate encoder 120. Both high rate encoder 110 and low rate encoder 120 are connected to multiplexer/exciter 130. Multiplexer/exciter 130 connects to antenna 140, which transmits, over the airwaves at a set broadcast frequency, the combined encoded signal to receive antenna 150. On the signal receiver side, antenna 150 connects to settop receiver 160. Settop receiver 160 connects to display device 170, which provide video and audio content display to a user.

High rate encoder 110 encodes the first data stream using one or more signal compression and error correction encoding processes. Signal compression may include MPEG-2 compression. Signal error correction encoding may include Reed-Solomon encoding, data randomizing, or whitening, data interleaving, and trellis coding. In general, high rate encoder 110 is capable of generating a video data signal achieving high definition video quality. High definition video quality may include a video signal in a progressive scan format having more than 720 lines of horizontal resolution. Other formats for high definition video quality may be possible.

Low rate encoder 120 may encode the second data stream by first configuring the second data stream into internet protocol (IP) packets, applying one or more signal compression and signal encoding processes including a packet based trellis encoding and a packet based Reed-Solomon encoding. Low rate encoder 120 may also compress and encode all or a portion of the second data stream at more than one encoding rate using the above mentioned encoding processes. In addition, low rate encoder 120 may include one or more of the signal encoding processes described and used high rate encoder 110. In general, low rate encoder 120 is capable of generating a video data signal achieving a low definition video quality. Low definition video quality may include a video signal in an interlaced scan format having less than 720 lines of horizontal resolution. Other formats for low definition video quality may be possible.

In a preferred embodiment, high rate encoder 110 encodes the first data stream according the ATSC A/53 signal standard and low rate encoder 120 encodes the second data stream as a packet based data stream according to the ATSC M/H or ATSC A/153 standard.

It is important to note that the content in the first data stream may be the same as, or similar to, the content in the second data stream. Although the content may be the same initially, the signal compression and encoding level of the content may be different in order to account for the difference in the signal encoding performance between high rate encoder 110 and low rate encoder 120. For instance, the output content from high rate encoder 110 may use a different video resolution or aspect ratio than the low rate encoder 120. Further, the received signal error threshold may be higher for the output of the high rate encoder 110. As a result, the signal stream from the low rate encoder 120 may be receivable without data signal errors at a lower signal to noise ratio at a receiving device.

Additionally, the content in the first data stream may be time advanced or time delayed in relation to the content in the second data stream. The time delay or advance may be necessary to adjust the transmission delivery timing of the signals from high rate encoder 110 and low rate encoder 120. Also, in some embodiments, the first data stream and second data stream may use different signal format or compression mechanisms. For instance, the first data stream may be an MPEG-2 stream while the second data stream may be an MPEG-4 stream.

Both high rate encoder 110 and low rate encoder 120 may include some or all of the video and audio compression processes described above. In this manner, both high rate encoder 110 and low rate encoder 120 may receive the same uncompressed video and audio signals. High rate encoder 110 and low rate encoder 120 may also include transport packet formation processing. High rate encoder 110 and low rate encoder 120 may also include signal format transcoding processes. For instance, high rate encoder 110 may include an MPEG-2 format to MPEG-4 format signal converter or an MPEG-4 to MPEG-2 format signal converter.

The encoded signal streams from high rate encoder 110 and low rate encoder 120 are provided to multiplexer/exciter 130. Multiplexer/exciter 130 combines the two encoded streams into a single stream for transmission. In one embodiment, multiplexer/exciter 130 constructs the combined signal stream as a continuous data stream originating from high rate encoder 110 with a set of positions or intervals in the continuous stream to include burst data as a packet based auxiliary data stream from low rate encoder 120. Multiplexer/exciter 130 may also synchronize the delivery of the two encoded signal streams by providing timing references within the signal. The timing references may be based on absolute timing signals, such as a clock, or may be based on relative position timing based on the content in, for instance, the encoded stream from high rate encoder 110. Multiplexer/exciter 130 may also include any final combined channel coding for the combined signal stream, such as trellis coded modulation encoding. Operation of encoders and a multiplexer/exciter will be described in further detail below.

It is important to note that the two encoded streams may co-exist as subchannels within the final combined signal. Although the two encoded streams may be interrelated and may include some common processing, each of the two streams, as subchannels, may be received, recovered, and decoded independently.

The combined signal is provided to antenna 140 and transmitted over the airwaves. It is important to note that the transmitted signal is intended for reception by both fixed broadcast receiving equipment as well as mobile or handheld receiving equipment. The presence of two encoded signal streams, having different performance levels, within the transmitted signal allows the signal to be received by two sets of receiving equipment based on two different reception performance levels. Fixed broadcast receiving equipment may receive the high quality stream based on nominal reception capabilities and an improved transmission channel environment. The high quality stream may then be displayed on a high resolution video display system, such as a high definition television. Mobile or handheld receiving equipment, such as cell phones, personal digital assistants, and portable televisions, may receive the low quality stream based on improved reception capabilities and a more difficult transmission channel environment. The low quality stream may then be displayed on the much smaller and lower resolution screen used in conjunction with the mobile or handheld receiving device.

Antenna 150 receives the transmitted signal containing the combined data stream and provides the signal to settop receiver 160. Settop receiver 160 tunes, demodulates, and decodes the received signal. In addition, settop receiver 160 also separates the received signal into content from the first data stream and content from the second data stream. In general, settop receiver 160 processes and decodes only the content for the first data stream from high rate encoder 110. However, as described herein, settop box receiver may also advantageously process and decode the content from the second data stream from low rate encoder 120. Details of the receiving and processing of the received signal containing the two data will be described in further detail below.

The output signal from settop receiver 160, as either the received and decoded data stream originally processed in high rate encoder 110 or the received and decoded data stream originally processed in low rate encoder 120, is provided to display device 170. Display device 170 may include a television, monitor, computer display or the like. In some embodiments, settop receiver 160 and display device 170 may be combined and implemented as a single receiving and display device.

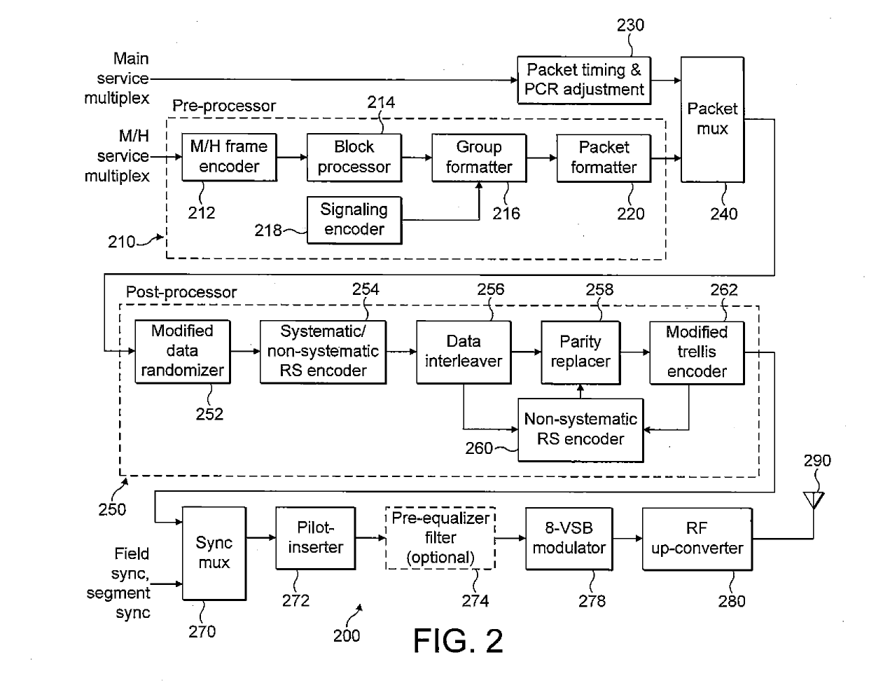

Turning now to FIG. 2, a block diagram of a signal transmitter system 200 according to aspects of the present disclosure is shown. Transmitter 200 encodes and transmits signals according to the ATSC M/H or A/153 broadcast standard. The transmitter 200 receives two sets of input streams, the MPEG transport stream (TS) packets of the main service data, and the M/H service data. Main service data is provided to packet timing and adjustment block 230. The M/H service data stream is provided to pre-processor 210. The outputs of packet timing and adjustment block 230 and pre-processor 210 are connected to packet mux 240. Packet mux 240 is connected to post-processor 250. The output of post-processor 250 is connected to sync mux 270. A field sync and segment sync signal are both provided as an input to sync mux 270. Sync mux 270 connects to pilot inserter 272. Pilot inserter 272 connects to pre-equalizer filter 274. The pre-equalizer filter 274 connects to 8-level vestigial sideband (8-VSB) modulator 278. The 8-VSB modulator 278 connects to upconverter 280. Upconverter 280 connects to antenna 290. Antenna 290 transmits the combined and processed streams, the main service data and M/H service data, as one or more ATSC A/153 broadcast signals.

Pre-processor 210 further includes several blocks associated with encoding the M/H service data stream. The input signal is provided to M/H frame encoder 212. The M/H frame encoder is connected to block processor 214. The block processor 214 is connected to the group formatter 216. A signaling encoder 218 also provides an input to group formatter 216. The group formatter is connected to the packet formatter 220. Packet formatter provides the output signal for the pre-processor 210.

Post-processor 250 further includes several blocks associated with encoding the combined data stream. The input signal is provided to modified data randomizer 252. The data randomizer 252 is connected to the systematic/non-systematic RS encoder 254. The systematic/non-systematic

RS encoder 254 is connected to data interleaver 256. The data interleaver 256 is connected to parity replacer 258. The data interleaver 256 is also connected to a non-systematic RS encoder 260. The parity replacer 258 is connected to the modified trellis encoder 262. One of the outputs of the modified trellis encoder 262 is connected as a feedback input to the non-systematic RS encoder 260. The non-systematic RS encoder 260 is connected as a second input to parity replacer 258. The modified trellis encoder 262 also provides the output signal for the post-processor 250. It is important to note that many of the blocks in post-processor 250 perform functions similar to those functions found in a signal encoding system for ATSC A/53 broadcast signals. The functions of some of the blocks have been modified or adapted to incorporate changes due to the presence of the additional ATSC M/H service data stream.

At a high level, the function of transmitter 200 involves combining the two types of streams, the higher data rate main service data and the lower data rate M/H service data, into one stream of MPEG transport stream packets and process and modulate them into the normal ATSC trellis-coded 8-VSB signal according to the A/53 standard. For compatibility with legacy 8-VSB receivers, the M/H service data is encapsulated in special MPEG-2 transport stream packets, designated as M/H Encapsulation (MHE) packets, in pre-processor 210. The pre-processor 210 can accommodate encapsulated service data that is in any desired format. For example, services carried in MPEG transport streams such as like MPEG-2 video/audio, MPEG-4 video/audio, other data, or services carried by IP packets may be processed.

Pre-processor 210 rearranges the M/H service data into an M/H data structure to enhance the robustness of the M/H service data. Forward error correction is performed in MH frame encoder 212 and block processor 214. Training sequences are added by signaling encoder 218 and group formatter 216. Packet formatter 220 subsequently encapsulates the processed enhanced data into MHE transport stream packets and formats the MHE packets as a Group of 118 consecutive packets of 207 bytes (or segments) to be inserted in the main service data stream.

The main service multiplex data is provided to the packet timing and adjustment block 230. Packet timing and adjustment block 230 adjusts the main service multiplex data to compensate for temporal displacements at the combining point so that the emitted signal complies with the MPEG and ATSC standards to permit operation of legacy receivers. Time-division multiplexing of main service and M/H service data introduces changes to the time of transmission of the main service stream packets compared to the timing that would occur with no M/H stream present. The temporally adjusted main service multiplex data from packet timing and adjustment block 230 and the processed MH service data from the pre-processor 210 are multiplexed, or combined, together in packet mux 240. At the packet mux 240, each M/H Group is inserted in an M/H Slot, consisting of 156 data packets, or half the size of an ATSC data field. M/H Slots may or may not contain M/H Groups. If an M/H Group is inserted in a particular Slot, then 118 packets are M/H packets and 38 packets are main service data packets. If no M/H Group is inserted in a Slot, then all 156 packets are main service data packets. The allocation of M/H Groups to M/H Slots shall be a function of the relative rates between the M/H data and the main service data.

The combined data stream is provided to post-processor 250. Post-processor 250 further encodes and processes the combined data stream. Post processor 250 is capable of recognizing, separating, and separately processing and encoding the main service data portion and the M/H service data portion of the combined data stream. Post-processor 250 processes and encodes the main service data using the 8-VSB encoding based on the A/53 standard. The encoding includes data randomizing in modified data randomizer 252, RS encoding in systematic/non-systematic RS encoder 254, data interleaving in data interleaving 256, and trellis encoding in modified trellis encoder 262.

Post-processor 250 also manipulates the pre-processed M/H service data in the combined stream to ensure compatibility with ATSC 8-VSB receivers. The M/H service data in the combined stream is processed differently from the main service data in post-processor 250. The M/H service data is passed through the modified data randomizer 252 and is not randomized. The pre-processed M/H service data is encoded as non-systematic data in systematic/non-systematic RS encoder 254 and interleaved, as a block of data containing 52 bytes, in data interleaver 256. Data interleaver 256 corresponds to the A/53 ATSC convolutional interleaver and equally applies to M/H and main service data. Additional operations are also performed on the pre-processed M/H service data in order to properly initialize a set of trellis encoder memories located in the modified trellis encoder 262 at the start of each training sequence included in the pre-processed M/H service data.

A systematic/non-systematic RS encoder 254 is used to perform the RS encoding process of the (N, K, t)=(207, 187, 10) code at the data output of modified randomizer 252. The systematic/non-systematic RS encoder 254 is a modified version of a standard ATSC RS encoder for the same RS code but reflects the modifications implied by the MH group data format table included as part of the A/153 standard. The non-systematic RS encoding of the MH service data allows the insertion of the regularly spaced long training sequences without disrupting reception by legacy receivers.

During operation of systematic/non-systematic RS encoder 254, if the inputted data corresponds to a main service data packet, the RS encoder performs the same systematic RS encoding process as in the legacy ATSC 8-VSB system, adding 20 bytes of RS FEC parity data at the end of each set of 187 information-byte packets, therefore creating a 207-coded byte packet or segment. However, if the inputted data corresponds to an M/H service data packet, the RS encoder performs a non-systematic RS encoding process.

Modified trellis encoder 262 operates in a manner similar to a conventional trellis encoder used in the ATSC A/53 broadcast standard. In operation, 12 interleaved rate ⅔ trellis encoders with differential pre-coding perform the encoding. Further, the inclusion the M/H data creates an additional need to initialize the encoder memories just prior to each M/H training sequence for the purpose of obtaining known training sequences used for receiving the ATSC M/H signal. In addition, the RS parity data calculated prior to the trellis initialization for the M/H signal will now contain errors prior to transmission. Modified trellis Encoder 262 supplies the changed initialization byte to the Non-Systematic RS Encoder 260. Non-systematic RS encoder 260, together with pre-interleaved data and control signals provided by data interleaver 256, calculates the new parity bytes to replace the erroneous parity bytes due to trellis initialization. These calculated parity bytes are provided to parity replacer 258 in order replace the original ones computed by systematic/non-systematic RS encoder and provided back to modified trellis Encoder 262.

The final output of modified trellis encoder 262 is provided to sync mux 270 and the remaining blocks in FIG. 2. These remaining blocks in FIG. 2 may be the same as, or similar to, blocks used in a signal transmission system for broadcasting a signal using the ATSC A/53 standard. Sync mux 270 inserts the ATSC A/53 synchronization, known as field and segment synchronization signals, to the data stream. Pilot inserter 272 inserts a small in-phase pilot to the data signal with the same frequency as the suppressed-carrier frequency. The optional pre-equalizer filter 274 filters the signal to compensate in advance for known system distortions and facilitate the reception. The 8-VSB modulator 278 modulates the 8-level trellis encoded composite data signal (including pilot and sync) in accordance with the A/53 specification, based on Vestigial Sideband modulation and a linear phase raised cosine Nyquist filter response in the concatenated transmitter and receiver and an intermediate frequency (IF) frequency of 44 MHz. Finally, RF up-converter 280 up-converts, or frequency shifts, the 8-VSB signal to the proper RF channel frequency to be broadcast via antenna 290.

It is important to note that it may be possible to eliminate the separate encoding blocks by combining the systematic/non-systematic encoder 254 and non-systematic encoder 260. In one embodiment, non-systematic RS encoder 260 may further be replaced by a memory and a processing block that multiplies the trellis encoded data by a stored weight value and replaces the data bytes in the MH service data portion of the combined data stream in order to initialize the trellis encoded data stream during the MH service data portion.

In operation, transmitter 200 receives content, as a first stream, encoded at a higher video quality and processes the higher quality level video for display on a video display in a home. The broadcast signal also receives the same or similar content, as a second stream, encoded at a lower video quality and processes the lower quality level video for display on a video display used with a portable or mobile device. The transmitter 200 processes the second stream separately to improve reception performance or robustness and in combination with the first stream. The transmitter 200 may also include a synchronization mechanism between the first stream and the second stream and synchronization data for the video content in each of the streams.

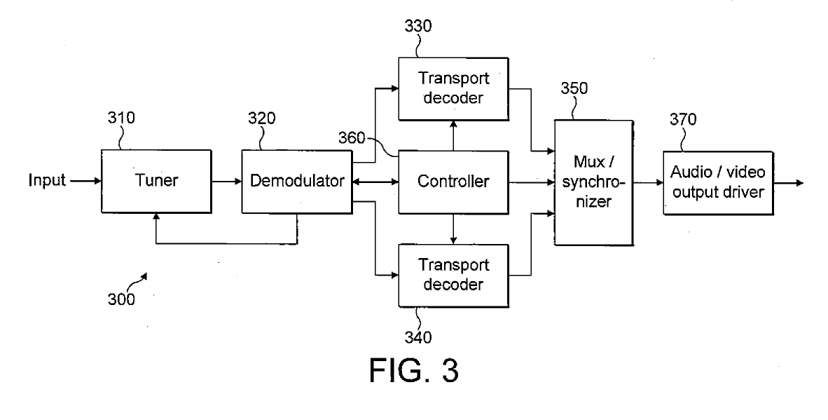

Turning now to FIG. 3, a block diagram of an embodiment of a receiver 300 according to aspects of the present disclosure is shown. Receiver 300 includes circuitry and processing for receiving and decoding signals that have been adversely affected by transmission of the signal over a transmission medium such as electromagnetic waves over the air. Receiver 300 is capable of decoding a fixed broadcast data stream, such a legacy data stream for ATSC. Receiver 300 may also be capable of decoding a more robust mobile or handheld broadcast data stream, such as a data stream used for ATSC M/H or A/153 included as part of a transmission signal according to the A/153 standard. For example, receiver 300 may be included in a receiver device capable of receiving and decoding a signal transmitted as an ATSC M/H signal including a legacy ATSC signal, such as settop receiver 160 described in FIG. 1 or a display device.

In receiver 300, the received signal is provided to tuner 310. Tuner 310 is connected to demodulator 320. Demodulator 320 is connected to both ATSC legacy transport decoder 330 and ATSC M/H transport decoder 340. Demodulator 320 also connects back to tuner 310. Both ATSC legacy transport decoder 330 and ATSC M/H transport decoder 340 are connected to mux/synchronizer 350. A controller 360 is connected to demodulator 320, ATSC legacy transport decoder 330, ATSC M/H transport decoder 340, and mux/synchronizer 350. Mux/synchronizer 370 is connected to audio/video output driver 370. Audio/video output driver 370 provides an audio signal and a video signal to a display device, such as a television, or home entertainment system for viewing by a user.

A signal containing encoded program streams with audio and video content is received and provided to tuner 310. Tuner 310 selects, or tunes, one or more channels that have been transmitted from various broadcast transmitters to produce one or more baseband signals. Tuner 310 contains circuits such as amplifiers, filters, mixers, and oscillators, for amplifying, filtering and frequency converting the split signal stream. Tuner 310 typically is controlled, or tuned, by either demodulator 320 or by another controller, such as controller 360, which will be described later. The control commands include commands for changing the frequency of an oscillator used with a mixer in tuner 310 to perform the frequency conversion of the received signal to baseband.

Typically the baseband signals at the output of tuner 310 may collectively be referred to as the desired received signal and represent one or more channels selected, or tuned, out of the group of broadcast channels that were received at the input. Although the signal is described as a baseband signal, this signal may actually be positioned at a frequency that is only near to baseband.

The one or more baseband signals from tuner 310 are provided to demodulator 310. Demodulator 310 typically contains the processing circuits, such as analog to digital (A/D) converters, derotators, timing synchronization loops, and equalizers, needed to convert the one or more baseband signals into a digital signal for demodulation by the remaining circuitry of demodulator 310. In one embodiment the digital signal may represent a digital version of the one or more baseband signals. In another embodiment the digital signal may represent the vector form of the one or more baseband signals.

Demodulator 320 also demodulates and performs error correction on the digital signal to produce one or more transport signals. Demodulator may include Reed Solomon and convolutional decoding circuitry for the received signal. The decoding circuits may decode the entire received signal and/or may decode individual subchannels or data streams within the received signal. In one embodiment, the main subchannel or data stream, containing the higher data rate higher quality video signal content, and the subchannel or data stream, containing the lower data rate lower quality video signal content may each be a separate transport stream. Each transport signal or stream may further represent a data stream for one program, often referred to as a single program transport streams (SPTS), or it may represent multiple program streams multiplexed together, referred to as a multiple program transport stream (MPTS).

In addition, demodulator 320 may determine an error rate for the entire received signal using, for instance, the error correction information or statistics from the error correction decoder circuits. Demodulator 320 may also compute an estimate of the received signal to noise ratio for the channel based on the error correction information or also based on information from other circuits, such as the equalizer circuit. Demodulator 320 may also compute or determine an error rate or signal to noise ratio for the separate demodulated transport streams in the received signal.

The one or more transport signals from demodulator 310 are provided to both transport decoder 330 and transport decoder 340. Both transport decoder 330 and transport decoder 340 typically separate the transport signal, which is provided as either a SPTS or MPTS, into individual program streams and control signals. Both transport decoder 330 and transport decoder 340 may also decode the program streams, and creates audio and video signals from these decoded program streams. Each of transport decoder 330 and transport 340 may only be capable of decoding specific types of program streams within the transport signal. In one embodiment, transport decoder 330 may be capable of decoding the high rate higher quality program streams that result in high definition video, such as ATSC legacy or A/53 program streams. Similarly, transport decoder 340 may be capable of decoding the low data lower quality program streams capable of producing video for a small screen on a mobile device, such as ATSC M/H or A/153 program streams.

Transport decoder 330 and transport decoder 340 may also decode only specific components or program streams within the transport signal. In one embodiment, transport decoder 330 is directed by user inputs or through a controller, such as controller 360, to decode only the one program stream containing high definition video program content that has been selected by a user and create only one audio and video signal corresponding to this one decoded program stream. During processing in transport decoder 330, controller 360 determines that a significant number of errors are occurring in the program stream provided to transport decoder. As a result, controller 360 may provide a control signal to transport decoder 340 to decode a program stream containing a lower definition version of the video program content that is associated with the current program stream in transport decoder 330. In another embodiment, transport decoder 330 and transport decoder 340 may be directed to decode all of the available program streams and then create one more audio and video signals depending on either user request or control signal from controller 360.

The audio and video signals, along with any necessary control signals, from transport decoder 330 and transport decoder 340 are provided to mux/synchronizer 350. Mux/synchronizer 350 manages the routing and interfacing of the audio and video signals to the audio/video output driver 370. Mux/synchronizer 350 also establishes and maintains timing aspects for the audio and video signals provided from transport decoder 330 and transport decoder 340. For example, mux/synchronizer 350 may detect or further decoder timing information provided as part of the control signals in each of the signals from transport decoder 330 and transport decoder 340. As a result of the timing information, mux/synchronizer 350 may delay one signal in time with respect to the other signal in order to better synchronize the delivery of audio and video content to a display device. In order to delay the one signal, a memory, such as a first in first out (FIFO) memory, not shown, may be used to store the one signal and may be controlled by either mux/synchronizer 350 or controller 360.

Audio/video output driver 370 processes and supplies the audio and video signals, either delivered as low definition video content or high definition video content, externally to a display device. Audio/video output driver 370 may also include video conversion processing circuits in order to properly display video content from transport decoder 340 (i.e. low definition or low quality video) on the high definition video display. For instance, audio/video output driver 370 may include a scan converter to convert interlaced video to progressive scan non-interlaced video. Audio/video output driver 370 may also include video upconversion circuits for converting a video signal with lower vertical and/or horizontal resolution to a resolution that is compatible with the display. Audio/video output driver 370 may also include aspect ratio conversion circuits to convert, for instance, 4:3 aspect ratio video to display on a 16:9 aspect ratio display.

It is important to note that one or more characteristics of the signal provided to transport decoder 340 (i.e. the lower rate lower quality video signal) may not be compatible with higher quality or higher definition display devices. As a result, signal conversion of the signal, including scan conversion or resolution conversion, may be necessary. Although the signal may be converted to operate and display on the higher quality or higher definition display devices, the image produced by the converted signal will not be equivalent in quality to a high quality video signal, such as the signal provided to transport decoder 330. The outputting and displaying of the lower quality signal in place of the higher quality signal is implemented in order to prevent complete or partial loss of a video display signal during a period of time when the performance of the signal provided to the transport decoder 330 (i.e. the higher rate higher quality video signal) has been impaired by signal transmission or reception issues. The impairments and reception issues may arise due to the movement of objects, such as a person walking in a room near the antenna, or atmospheric changes, such as rain or snow. The impairment or reception issue may generally only exist for a short period of time but also may repeatedly occur over time.

Receiver 300 may also include other elements, not shown, such as a memory, external communications interface, user interface, and power supply, as well known to those skilled in the art. Memory may be used for content recording and storage as well as storage of operating information. Examples of memory include random access memory (RAM), flash, hard media such as a hard disk drive. Examples of an external communication interface may include a phone modem for providing phone connection to a service provider or an Ethernet connection. Examples of a user interface include a user panel or remote control device and associated signal receiver. Finally, the power supply typically connects to all of the blocks in receiver 300 and supplies the power to those blocks.

It should be appreciated by a skilled artisan that the blocks described in receiver 300 have important interrelations, and some blocks may be combined and/or rearranged and still provide the same basic overall functionality. For example, demodulator 320, transport decoder 330, and transport decoder 340 may be combined. The combined circuit may further integrate some or all of the functions of controller 360 and mux/synchronizer 350 to act as the main decoder/controller for receiver 300. Further, control of various functions may be distributed or allocated based on specific design applications and requirements, such as use in a settop box or television device.

In operation, receiver 300 receives a signal that contains a first stream encoded using a first encoding rate or format that produces a first quality level of picture output for display. The received signal also contains a second stream containing the same or similar content and encoded using a second encoding rate or format that is higher, or more robust, than the first encoding rate that produces a second quality level of picture output for display that is lower that the first quality level. The second stream may include video characteristics, such as lower video resolution and lower scan rate resolution that result in the lower quality level of picture output compared to the first stream. The receiver 300 decodes the first stream and outputs the first decoded stream for display on a display device if the decoding error rate remains below a first decoded signal error level.

If the decoding error rate of the first stream goes above the first decoded signal error level, the receiver 300 may decode the second stream and output the second decoded stream for display on the display device. The receiver/decoder may also initiate decoding the second stream while the first stream is still being decoded, such as when the decoding error rate reaches a second different error rate, and may not decode the second stream otherwise. The receiver 300 may also include the ability to synchronize the outputs of the two decoded streams for a seamless display transfer. The receiver 300 may convert the video signal from the second decoded stream based on one or more video signal characteristics in order to display the second stream on the display device for the first quality level of picture output.

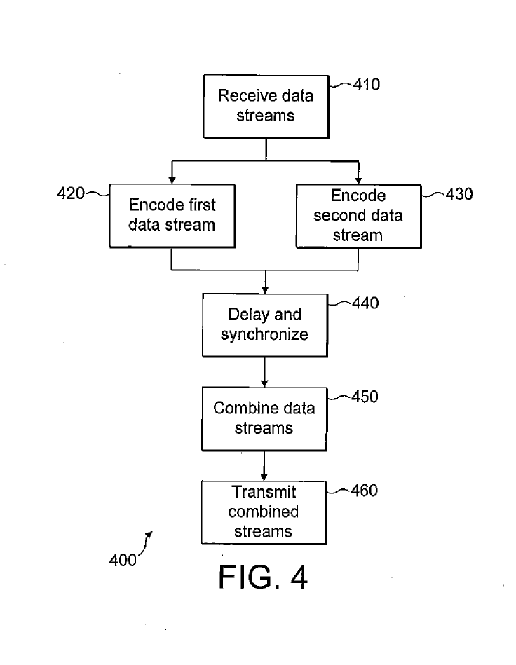

Turning now to FIG. 4, a flow chart for an embodiment of a signal encoding process 400 including aspects of the present disclosure is shown. Process 400 includes encoding signal streams for use in both a high quality video signal transmission, such as the ATSC legacy transmission and a low quality video signal transmission, such as the ATSC M/H transmission. Process 400 will be described primarily with reference to transmitter 200 in FIG. 2. However, process 400 may equally be applied to the transmitter blocks, such as high rate encoder 110, low rate encoder 120, and multiplexer/exciter 130 described in FIG. 1.

At step 410, one or more data streams are received from a signal source. In one embodiment, the signal streams contain the same video program material but at a different video resolution. In another embodiment, a single video stream is used. The streams received at step 410 may be supplied to encoder circuits or blocks, such as packet timing and adjustment block 230 and pre-processor 210. Additionally, the received data stream may include, or be accompanied by, one or more control signals for directing aspects of the signal processing, such as encoding.

At step 420, the single video stream, or alternatively, the higher video resolution video stream is encoded as a high rate data stream. In one embodiment, the encoding at step 420 involves encoding the signal using the ATSC A/53 legacy broadcast standard. The encoding at step 420 is performed prior to, or as part of, packet timing and adjustment block 230 and may include broadcast packet formation and video compression, such as MPEG-2, compression. The encoding at step 420 may also include data error correction encoding such as Reed-Solomon encoding.

At step 430, the same single video stream, or alternatively, the lower resolution video stream is encoded as a low rate data stream. In one embodiment, the encoding at step 430 involves encoding the signal using the ATSC A/153 M/H standard. The encoding at step 420 is performed in pre-processor 210 and may include internet protocol packet formation and video compression, such as MPEG-4 compression. The encoding at step 420 may also include data error correction specific to a mobile internet packet structure and may also include error correction encoding similar to that described above at step 420.

Next, at step 440, the results from step 420 and the results from step 430 are time delayed and/or synchronized together. The synchronization at step 440 permits a receiver capable of receiving both the high rate video stream and the low rate video stream as part of the same signal transmission and to seamlessly switch between the two streams depending on the signal reception conditions. The delay and synchronization may be carried out in packet timing and adjustment block 230 as well as pre-processor 210. In one embodiment, timing information may be added to one or both video streams, or as additional control data in order to identify synchronization between the two streams.

It is important to note that the delay and/or synchronization may be statically or dynamically adjustable. For example, timing information may be added to one or both streams, or a timing delay introduced between the two streams, based on external or empirical observation of the content in the two streams. Further, periodic synchronization data may be added to one or both streams and used during the receiving and displaying of the streams. Alternatively, synchronization between the two streams may be adjusted during the encoding and transmission process based on monitoring information in the content within the two streams.

At step 450, the synchronized data streams are combined and channel coded. The data stream combining is carried out in M/H framing block 230. The combining at step 450 may include establishing the first high rate data stream encoded in step 420 as a continuous data stream. The combining at step 450 then identifies specific interval locations within the continuous data stream for inserting portions of the second low rate data stream encoded in step 430. In one embodiment, the combining at step 450 is carried out based on the ATSC A/153 standard. Further, at step 450, channel coding may be carried out in a circuit, such as post-processor 250. Channel coding may include parity coding, such as Reed-Solomon encoding, as well as data interleaving, and trellis-coded modulation.

At step 460, the coded and combined data stream is transmitted. The transmitting at step 460 is carried by 8-VSB modulator 278, RF upconverter 280 and antenna 290 and may include transmitting the processed stream containing multiple programs of audio and video content a single broadcast signal as a single channel on a broadcast frequency. Alternatively the processed stream may be transmitted as multiple broadcast signals on different channels at different frequencies.

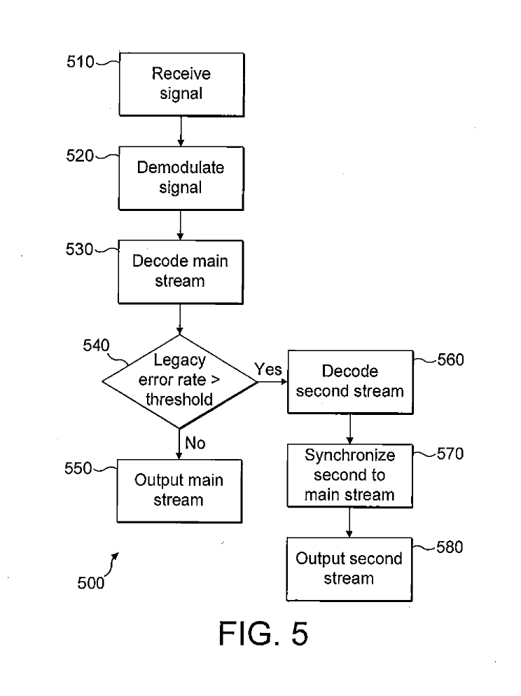

Turning now to FIG. 5, a flow chart for an embodiment of a signal decoding process 500 including aspects of the present disclosure is shown. Process 500 includes decoding a received signal containing video program streams encoded as a higher quality video signal, such as a legacy ATSC signal and a lower quality video signal, such as an ATSC M/H signal. Process 500 will be described primarily with reference to receiver 300 in FIG. 3. However, process 500 may equally be applied to a complete receiving system, such as settop receiver 160 described in FIG. 1.

At step 510, the transmitted signal, containing video content encoded in a manner such as described in process 400 in FIG. 4, is received. The receiving at step 510 may include tuning or selecting the desired channel or channels from a set of broadcast channels in the received signal. The receiving at step 510 may primarily be carried out in a tuner, such as tuner 310. Next, at step 520, the one or more channels in the received signal are demodulated. The demodulation at step 520 may include all or a portion of the channel decoding, signal timing, error correction, and channel equalization. The demodulation at step 520 may primarily be carried out in demodulator 320.

At step 530, the high rate video stream portion of the demodulated signal is decoded. In one embodiment, the high rate video stream portion represents the main broadcast signal or subchannel in the broadcast channel and includes a high definition video program stream. The decoding at step 530 may include transport packet identification and parsing as well as video compression decoding, such MPEG-2 decoding. The decoding at step 530 may also include extraction of control and timing information. The decoding at step 530 is primarily carried out in transport decoder 330.

At step 540, the error rate associated with the decoding of the high quality video stream portion at step 530 is determined and compared against an error rate threshold. In one embodiment, the high rate video stream may be fully decoded without producing errors that result in video display errors if a packet error rate for the received signal is below 0.0002 (2e⁻⁴), or one error in every 5000 received packets. For this high quality video stream signal, this packet error rate corresponds to a signal to noise ratio (SNR) for the received signal equal to 16 decibels (dB). If the error rate remains below this first packet error rate value, then the decoder error correction system for the high rate video stream is capable or correcting the error prior to providing the output signal. If the error rate exceeds this first error rate, then some errors will be present in the output signal and may remain as part of the video display signal. The errors often appear as “frozen” blocks on noncontiguous video content in the display. The error rate determination at step 540 may primarily be carried out in demodulator 320 or in transport decoder 330. Alternatively, the values used for the error rate determination may be generated in demodulator 320 or transport decoder 330 and processed in controller 360.

It is important to note that error rates for each of the separate program streams in the channel may be calculated. For instance, the signal error rate, or bit error rate may be determined separately for the main signal or subchannel within the received channel (e.g. the high rate video stream portion) as well as the subchannel containing the low rate video stream. Alternatively, a bit error rate may be determined for the entire selected broadcast channel and converted into an estimate for the signal to noise ratio. In general, the higher the bit error rate for a signal, the lower the received signal to noise ratio for that signal. Methods for determining error rates such as bit error rate or an estimate for the signal to noise ratio are well known to those skilled in the art, and include, but are not limited to monitoring the error correction statistics and estimating the equalizer tap conditions.

If, at step 540, the error rate is determined to be below an error rate threshold (e.g. packet error rate of 2e⁻⁴), then the main video stream in the broadcast channel containing the high bit rate high definition video program content can be displayed without error. At step 550, the high quality video stream is provided to a display device. The providing step 550 may be carried out by mux/synchronizer 350 and audio/video output driver 370. Alternatively, instead of an error rate threshold, an estimated signal to noise ratio for the received signal (e.g. 16 dB) may be used for determining a threshold at step 540.

If at step 540, the error rate is above the error rate threshold, then at step 560 the process begins decoding the low rate video portion of the demodulated stream. In one embodiment, the low rate video stream portion represents a subchannel in the broadcast signal and includes a lower definition video program stream than the video program stream provided as the main signal. The decoding at step 560 may include transport packet identification and parsing as well as video compression decoding, such MPEG-4 decoding. The decoding at step 560 may also include depacketization of the data in order to recover a continuous data stream from the packets of data delivered at intervals within the broadcast channel. The decoding at step 560 may also include extraction of control and timing information. The decoding at step 560 is primarily carried out in transport decoder 340.

At step 570, the synchronization information in one or both of the program streams or portions of the signal is identified. The synchronization information allows a receiving device to identify the content received as part of the low rate video program stream that most closely matches the content received as part of the high rate video program stream. As described above, the synchronization information may identify a static timing adjustment (e.g. a fixed time delay) or a dynamic timing adjustment (e.g. a variable time delay) for one or both of the video program streams. The synchronization step 570 may include determining the delay information as well as delaying the high quality video program stream or the low quality video program stream (e.g. storing the stream in a memory) in order to accommodate a changeover of the program streams provided to a display device.

Then, at step 580, the low rate video stream is provided to the display device, in place of the high rate video stream. In addition, at step 580, low rate video stream may undergo any video signal processing, such as scan conversion, resolution conversion, or aspect ratio conversion, as described above, prior to being provided to the display device. The processing and providing of the audio and video signal at step 580 is performed by audio/video output driver 370. Furthermore, controller 360 or mux/synchronizer 350 may introduce hysteresis to the switching in order to prevent undesirable display effects due to the switching of the streams.

It is important to note that the steps described in process 500 represent an embodiment allowing for separate processing of the high rate video signal and decoding and processing of the low rate video signal only when the high rate video signal cannot be properly decoded without errors (i.e. with an error rate below a threshold) and/or displayed. In another embodiment, the processing of the low rate video signal may be initiated at a point in time before the time when the high rate video signal cannot be properly decoded without errors and/or displayed. For instance, the decoding at step 560 may be initiated using another, or second, error rate threshold that represents a performance level approaching a level of performance degradation for the signal, such as a packet error rate of 1e⁻⁴ or 18 dB SNR for the received signal. In addition, the synchronization step 570 may also be initiated. Other intermediate type error threshold determinations may also be used, such as monitoring average error rates (e.g. packet error rate or SNR) over a period of time or counting the number of times the error rate previously reached an error threshold level. Then, if the error rate reaches the error rate value similar to the value indicated above at step 540, the low rate video signal may be provided for display in place of the high rate video signal without any additional potential delay in decoding and synchronizing the low rate video program stream. The decoding and switching of the program stream signals may be controlled by controller 360 and performed in mux/synchronizer 350.

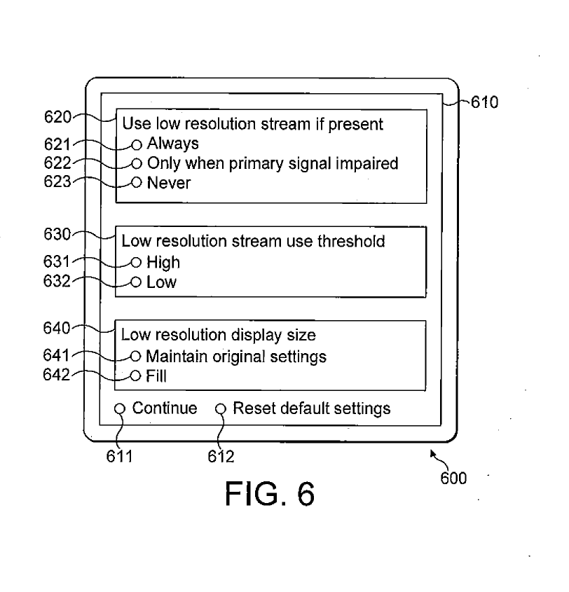

The exemplary processes described above may also utilize a user interface to allow a user to control portions of the processes. An exemplary display screen 600 for a user interface associated with aspects of the present disclosure is shown in FIG. 6. Display screen 600 includes several visual display elements that include selectable radio buttons. Navigation between, and selection of, the radio buttons may be performed through control or movement of an on-screen cursor. The navigation and control of the cursor may use any one of several user interface navigation devices including, but not limited to, a keypad, a remote control, a mouse, a gyroscopically controlled pointing device, and a capacitive touch pad. Display screen 600 may be displayed as part of a larger set-up system in the user interface of the device including the processes, such as a receiver device described in FIG. 3.

User interface 600 includes visual display element 610, illustrating a set of features associated with control of the device under the heading “Signal Quality Settings”. Within display element 610, several smaller visual display elements with radio button selection choices appear for selection by the user. Display element 620, identified as “Use low resolution stream if present”, contains three radio buttons 621-623 labeled “Always”, “Only when primary signal cannot be received”, and “Never” respectively. A selection choice in display element 620 controls the overall operation of the signal decoding process 500 described in FIG. 5. The user may select one of these radio buttons by navigating with a cursor control to the desired radio button and hitting an “enter” or “OK” key.

Display element 630, identified as “Low resolution stream threshold”, contains two radio buttons 631-632 labeled “High” and “Low” respectively. The selection choices in display element 630 allows the user to select, or adjust, the characteristics and timing for switching between outputting and/or displaying the high rate, or normal, video signal and the low rate video signal described in signal decoding process 500. The selection choices in display element 630 may be coupled to one or more of the SNR thresholds described above. The user may select one of these radio buttons by navigating with a cursor control to the desired radio button and hitting an “enter” or “OK” key. Selecting the “High” radio button 631 indicates that the process will begin decoding and/or outputting the low rate or low resolution video stream when decoding of the high rate or high resolution quality stream results in a small number of decoding errors. In one embodiment, when the high radio button 631 is selected, decoding of the low rate video stream is initiated when the error rate of the high rate signal reaches 1e⁻⁴ and the low rate video stream is output in place of the high rate video stream when the error rate reaches 2e⁻⁴.

Selecting the “Low” radio button 632 indicates that the process will begin decoding and outputting the low rate or low resolution video stream when the high rate video stream cannot be received at all or reaches a higher error rate than for radio button 631, such as 2e⁻⁴.

Display element 640, identified as “Low resolution picture size”, contains two radio buttons 641-642 labeled “Maintain original settings”, and “Fill” respectively. Display element 640 controls the conversion of the low rate or low resolution signal stream for use on a higher quality or higher resolution display screen. The user may select one of these radio buttons by navigating with a cursor control to the desired radio button and hitting an “enter” or “OK” key. Selecting the “Maintain original settings” radio button 641 indicates that the process will utilize the image size based on the resolution of the received low rate video program in the received signal stream. Selecting the “Fill” radio button 642 indicates that the process will convert the image size based on the resolution of the high rate video program in the received signal stream. The resolution conversion may use techniques described above, or other well known scaling and conversion techniques to allow the low rate lower resolution signal to be displayed on the higher resolution display screen in a manner similar to the high rate video signal.

Display element 610 also includes two radio buttons 611-612 labeled “continue” and “reset default settings” respectively. Selecting the “continue” button 611 exits the display 600 and returns the user interface to a previous operation, such as displaying the video content or a different user interface display screen. Selecting the “reset default settings” button 612 restores each of the selections in the display elements 620, 630, and 640 to an original state. In one embodiment, the factory default settings include selection of the “Never” button 623, “High” button 631, and “Fill” button 642.

It is important to note that selecting the “Always” button 621 or the “Never” button 623 may alter the remainder of the user interface display. If these buttons are selected then certain further selections within display element 610 may not be necessary. Some or all of the remaining entries in display element 610 may be removed or eliminated from display in display element 610. Alternatively, some or all of the remaining entries in display element 610 may be grayed or shaded to indicate no choice is necessary or permitted for those remaining entries.

The disclosed embodiments describe an apparatus and method for transmitting a broadcast signal that includes content, as a first stream, encoded at a higher data rate and producing the higher quality level video for display on a video display in a home. The broadcast signal also includes the same or similar video image content, as a second stream, encoded at a lower data rate and producing the lower quality level video for display on a video display used with a portable or mobile device. The transmission apparatus and method may also include synchronization between the first stream and the second stream and may include synchronization data for the video content in each of the streams within the combined broadcast signal.

The embodiments also describe an apparatus and method for receiving a signal that contains a first stream encoded using a first encoding rate or type and producing a first quality level of picture output for display, and a second stream containing the same content (audio, video, data) and encoded using a second encoding rate or type that is higher, or more robust, than the first rate and producing a second quality level of picture output for display that is lower than the first quality level. The first quality level of picture output may include higher video resolution and also may include higher scan rate resolution than the second quality level of picture output. The receiver decodes the first stream and outputs the first decoded stream for display if the decoding error rate remains below a first decoded signal error level.

The receiver may decode the second stream and output the second decoded stream for display if the decoding error rate goes above the first decoded signal error level. The receiver may decode the first and second streams simultaneously or alternatively may decode the second stream only if the first decoded signal error is above a second error level that is below the first error level. The receiver may further include the ability to disable the decoding of the second stream under certain receiving conditions such as when the error rate of the first decoded stream is below a second error rate which is lower than the first error rate. The receiver may also include the ability to synchronize the outputs of the two decoded streams for a seamless display transfer. The receiver may include the ability to adjust one or more video signal characteristics of the second stream in order to display the second stream on the display device for the first quality level of picture output.

While the embodiments may be susceptible to various modifications and alternative forms, specific embodiments have been shown by way of example in the drawings and have been described in detail herein. However, it should be understood that the disclosure is not intended to be limited to the particular forms disclosed. Rather, the disclosure is to cover all modifications, equivalents and alternatives falling within the scope of the disclosure as defined by the following appended claims.

1. A method comprising the steps of:
receiving a signal containing a first data stream encoded at a first encoding rate and a second data stream encoded a second encoding rate;
outputting first content from the first data stream if an error value of the first data stream is below a first error value; and
outputting second content from the second data stream if the error value of the first data stream is above the first error value.

2. The method of claim 1, wherein the first content and the second content contain the same video images.

3. The method as claimed in claim 2, wherein the signal contains synchronization information, the synchronization information indicating that the first stream and the second stream are synchronized based on the video images.

4. The method as claimed in claim 3, further comprising the step of adjusting a time for the output of the first content from the first stream based on the synchronization information.

5. The method as claimed in claim 1, further comprising the steps of:
decoding the first data stream to using a first decoding process produce the first content; and
decoding the second data stream using a second decoding process to produce the second content.

6. The method as claimed in claim 5, wherein the step of decoding the second data stream is disabled if the error value of the first decoded stream is below the first error value.

7. The method as claimed in claim 5, wherein the second data stream is decoded if the error value of the first data stream is below the first error value and above a second error value.

8. The method as claimed in claim 1, wherein the step of outputting the second content from the second data stream further includes outputting the second content at a lower video quality than the first content from the first data stream.

9. The method as claimed in claim 1, wherein the step of outputting the second content from the second data stream further includes converting video content of the second stream in order to display the second content on a video display capable of displaying the first content.

10. A signal receiving apparatus comprising:
a demodulator that receives a signal containing a first portion encoded at a first encoding rate and a second portion encoded at a second encoding rate;
a controller coupled to the demodulator, the controller determining whether an error rate of a decoded first portion of the signal is above a first error rate; and
an output driver coupled to the controller, the output driver providing a video signal from a decoded second portion of the signal if the decoded first portion of the signal is above the first error rate.

11. The signal receiving apparatus as claimed in claim 10, wherein the first portion and the second portion of the signal include the same video images.

12. The signal receiving apparatus as claimed in claim 11, wherein the signal contains synchronization information to synchronize the first portion and the second portion of the signal.

13. The signal receiving apparatus as claimed in claim 12, wherein the output driver further provides a video signal from the decoded first portion of the signal if the decoded first portion of the signal is below the first error rate and the signal receiving apparatus further comprises a synchronizer coupled to the controller, the synchronizer synchronizing the decoded first portion of the signal with decoded second portion of the signal.

14. The signal receiving apparatus as claimed in claim 10, further comprising:
a first decoder coupled to the demodulator, the first decoder decoding the first portion of the signal to produce the video signal from the first portion of the signal; and
a second decoder coupled to the demodulator, the second decoder decoding the second portion of the signal to produce the video signal from the second portion of the signal.

15. The signal receiving apparatus as claimed in claim 14, wherein the second decoder is disabled if the error rate of the decoded first portion of the signal is below the first error rate.

16. The signal receiving apparatus as claimed in claim 14, wherein the second decoder decodes the second portion of the signal is decoded if the error rate of the decoded first portion of the signal is above the first error rate and below a second error rate.

17. The signal receiving apparatus of claim 16, wherein the output driver further outputs decoded video content from the second stream if the error rate of the first stream is above the first error rate.

18. The signal receiving apparatus as claimed in claim 10, wherein the output driver further provides the video content of the second portion of the signal at a lower video quality than the video content of the first portion of the signal.

19. The signal receiving apparatus as claimed in claim 10, wherein the output driver further converts video content of the second portion of the signal in order to display the second stream on a video display capable of displaying video from the first portion of the signal.

20. An apparatus comprising:
means for receiving a signal containing a first data stream at a first encoding rate and a second data stream at a second encoding rate;
means for decoding the first data stream;
means for decoding the second data stream if an error value for the decoded first data stream is above a first error value; and
means for outputting content from the decoded second data stream if the error value of the decoded first data stream is above a second error value.

21. The apparatus of claim 20 wherein the second error value is higher than the first error value.

22. The apparatus of claim 20 wherein the means for outputting includes means for outputting content from the decoded first data stream if the error value of the decoded first data stream is below the first error rate.

23. The apparatus of claim 20 further comprising means for synchronizing the content from the decoded first data stream with the content from the decoded second data stream.

24. A method for displaying selections for a signal decoding process on an interactive graphic display in response to an input device, the method comprising the steps of:
displaying a plurality of visual elements associated with decoding a received signal containing a first data stream encoded at a first encoding rate and a second data stream encoded a second encoding rate; and
selecting a decoding process for the received signal in response to a user input, the decoding process further including:
outputting first content from the first data stream if an error value of the first data stream is below a first error value; and
outputting second content from the second data stream if the error value of the first data stream is above the first error value.

25. The method of claim 24, wherein the plurality of visual elements includes at least one of a selection turning on the decoding process and turning off the decoding process.

26. The method of claim 24, wherein the plurality of visual elements includes a first selection for outputting the second data stream when the error value of the first data stream is above the first error value and a second selection for outputting the second data stream when the error value of the first data stream is above a second error value.

27. The method of claim 24 wherein the plurality of visual elements includes a selection for converting video content of the second stream in order to display the second content on a video display capable of displaying the first content.
